(19) United States
(12) Patent Application Publication
(10) Pub. No.: US 2023/0331518 A1
(43) Pub. Date: Oct. 19, 2023

(54) ELEVATOR BACK-UP BATTERY SYSTEM

(71) Applicant: LiiON, LLC, East Dundee, IL (US)

(72) Inventors: Gary L. GRAY, Tampa, FL (US); Thomas LYNN, Malvern, PA (US)

(73) Assignee: LiiON, LLC East Dundee, East Dundee, IL (US)

(21) Appl. No.: 17/984,899

(22) Filed: Nov. 10, 2022

Related U.S. Application Data
(60) Provisional application No. 63/277,703, filed on Nov. 10, 2021.

(51) Int. Cl. B66B 11/04; B66B 1/28; B66B 5/02

(52) U.S. Cl. CPC B66B 11/043; B66B 1/28; B66B 5/028

(57) ABSTRACT

A battery system for providing standby power to an elevator system is disclosed. The battery system includes a lithium battery cell, a lithium battery module comprising electrically connected cells, a control unit, and a networking unit. The battery system is electrically and communicatively connected to the elevator system and adapted to drive the elevator system when a main power supply is interrupted. Various battery system metrics are reported to the elevator system and, optionally, to a central monitoring station.

### CROSS-REFERENCE TO RELATED APPLICATION

This is a non-provisional US patent application claiming priority under 35 U.S.C. § 119(e) to U.S. Provisional Patent Application No. 63/277,703 filed on Nov. 10, 2021.

### TECHNICAL FIELD

The present disclosure relates generally to elevator systems and, more specifically, relates to an elevator back-up battery system for providing standby power to elevators.

### BACKGROUND

Many elevator installations, particularly those in high-rise buildings having many floors, include emergency power systems that allow limited operation of the elevator during blackout conditions. These emergency power systems may be supplied by batteries or, more commonly, standby generators run by fuel-driven engines. However, due to the limited power supplied by these systems, full functionality of all elevator cars cannot be maintained during emergencies, and the respective operation of each car must be prioritized. For instance, it is often the case that, when the emergency power system is activated, each carriage immediately cancels any pending calls and returns to the main lobby one at a time. Once all cars have returned to the lobby, individual cars may be manually or automatically selected to handle emergency services, so as to avoid overloading the emergency power system. Unfortunately, these power systems may be inadequate in providing emergency services to those who are physically handicapped or otherwise disadvantaged, particularly in time sensitive situations. By limiting the number of operational cars and the range of these cars, the emergency power systems of the prior art may fail to timely reach those individuals most in need.

One example of an emergency power system in the art is described in U.S. Pat. No. 4,379,597 invented by Frederick H. Nowak and assigned to the Otis Elevator Company. This patent discloses a multi-elevator system emergency protocol, whereupon the loss of building power, elevator operation is prioritized by an automatic group controller to maximize car recovery. In a first phase, an attempt is made to recover each car to the main lobby; and in a second phase, cars are selected to run on a priority basis in which the highest level are cars with firemen, followed by cars preferred to be run on emergency power. While the system of Nowak is designed to maximize rescue efforts through improved resource allocation, its limited emergency power source must nonetheless reduce the number of cars in operation and the number of calls obeyed.

Accordingly, there remains a need in the art for an elevator back-up battery system capable of supplying sufficient power to an elevator system to sustain core functionality during blackout conditions, thereby ensuring that no residents are left behind.

### SUMMARY OF THE DISCLOSURE

According to one aspect of the disclosure, an elevator back-up battery system for providing standby power to an elevator system is disclosed. The battery system includes a lithium battery cell, the cell having one or more cell metrics; a lithium battery module comprising electrically connected cells, the module having one or more module metrics; a control unit communicatively connected to the modules and configured to balance power across the modules, monitor the module metrics, compile one or more battery system metrics, and calculate one or more last run scenarios; and a networking unit communicatively connected to the control unit and the elevator system and configured to communicate the battery system metrics and the last run scenarios to the elevator system.

According to a second aspect of the disclosure, a method for providing standby power to an elevator system is disclosed. The method includes providing a lithium battery cell, a lithium battery module, a control unit, and a networking unit; connecting, electrically, the cells in each module; connecting, electrically, each module to the elevator system; connecting, communicatively, each module to the control unit; connecting, communicatively, the networking unit with the control unit and the elevator system; balancing, with the control unit, power across each module; monitoring, with the control unit, one or more module metrics; compiling, with the control unit, one or more system metrics; calculating, with the control unit, one or more last run scenarios; and communicating, with the networking unit, the system metrics and the last run scenarios to the elevator system.

According to a third aspect of the disclosure, an elevator system is disclosed. The elevator system includes an elevator shaft, an elevator car adapted to traverse the shaft, an elevator controller, and an elevator back-up battery system according to any one of the above aspects of the disclosure.

These and other aspects and features of the present disclosure will be more readily understood after reading the following detailed description in conjunction with the accompanying drawings.

### BRIEF DESCRIPTION OF THE DRAWINGS

FIG. 1 is a schematic illustration of an elevator system, elevator back-up battery system, and associated infrastructure in accordance with the present disclosure;

FIG. 2 is a schematic illustration of components of an elevator back-up battery system in accordance with the present disclosure;

FIG. 3 is a perspective view of components of another elevator back-up battery system in accordance with the present disclosure;

FIG. 4 is a flow diagram of a method for providing standby power to an elevator system in accordance with the present disclosure;

FIG. 5 is a schematic illustration of an elevator system in accordance with the present disclosure.

### DETAILED DESCRIPTION

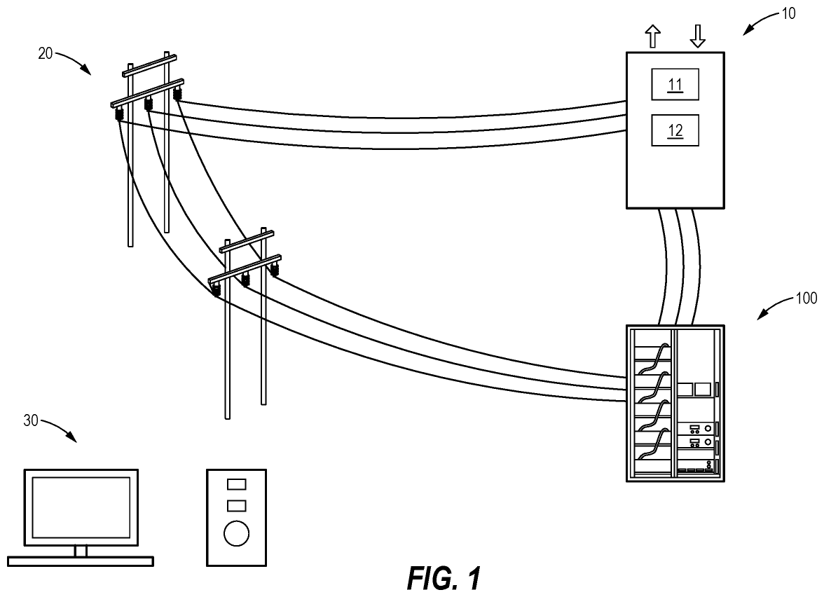

FIG. 1 is a schematic illustration of an elevator system 10, elevator back-up battery system 100, and associated infrastructure in accordance with the present disclosure, including a power grid 20 and central monitoring station 30. The elevator system 10 may comprise one or more elevator cars 11 controlled by one or more elevator controllers 12. Under normal operating conditions, the elevator system 10 and battery system 100 are respectively driven and charged by electrical power supplied through the power grid 20. However, under blackout conditions, or when electrical power from the grid 20 is otherwise interrupted, the battery system 100 instead discharges electrical power to drive the elevator system 10. The battery system 100 may provide electrical power to one or multiple cars 11 and to one or multiple elevator controllers 12 through any number of intervening infrastructures (e.g. transformers, converters, rectifiers, etc.). Furthermore, the battery system 100 is communicatively connected to the elevator system 10, and in particular to the elevator controllers 12, such that various metrics of the battery system 100 may be relayed thereto.

In one embodiment, the battery system 100 is configured to store a minimum level of charge corresponding to the size of the connected elevator system 10. In particular, the battery system 100 is configured to supply adequate standby power to the elevator system 10 for each of the driven cars 11 to complete two roundtrips carrying a full capacity with elevator doors opening and closing on each landing. While being driven by the battery system 100, the cars 11 may operate at reduced speeds and/or be otherwise optimized to consume less power.

The battery system 100 may further comprise a DC charger capable of float charging between 545V and 580V, although different charging voltages are also envisioned. During discharge, the battery system 100 may output a maximum voltage of 575V or greater and a minimum voltage of 400V or less. The battery system 100 may further provide at least 60 kW of continuous DC drive to the elevator system 10 and upwards of 250 kW of DC drive for at least 1 minute.

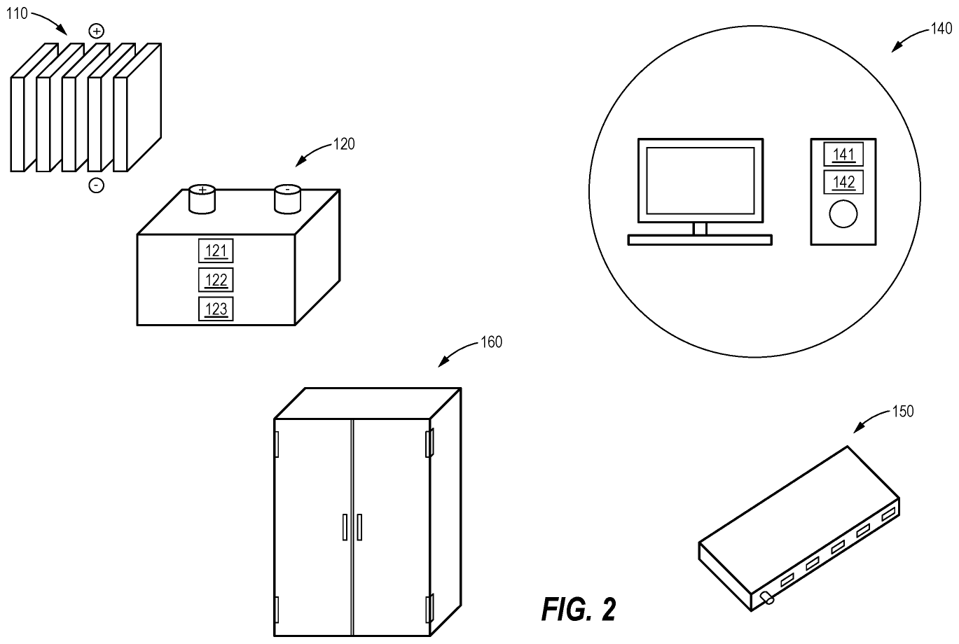

Turning now to FIG. 2, a schematic illustration of components of an elevator back-up battery system 100 in accordance with the present disclosure is provided. The battery system 100 comprises a battery cell 110, a lithium battery module 120 comprising electrically connected cells 110, a control unit 140 communicatively connected to the modules 120, and a networking unit 150 communicatively connected to the control unit 140 and the elevator system 10. In an embodiment, the battery system 100 further comprises a battery enclosure 160.

The cell 110 is understood to be a basic electrical chemical unit containing at least an electrode, anode, separator, and electrolyte, and being capable of multiple charge and discharge cycles. In one embodiment, lithium iron magnesium phosphate is selected as the cathode material, but other materials such as lithium cobalt oxide, lithium manganese oxide, lithium iron phosphate, and nickel manganese cobalt may be employed as well. In an embodiment, the cell 110 has a nominal voltage range between 2.0V and 4.2V and conforms to UL 1642—“UL Standard for Safety of Lithium Batteries.”

One or more cells 110 may be connected to form each lithium battery module 120 of the battery system 100. Any number of cells 110 may comprise one module 120 and any type or number of intervening structures (e.g. cell packs) may electrically couple the cells 110 of a module 120. Furthermore, the cells 110 comprising each module 120 may be configured in series, parallel, or any combination of known circuits in order to deliver the desired charge, voltage, current, or power required by the specific application.

In one embodiment, each module 120 further comprises an active balancing circuit 121 configured to balance power across the cells 110 comprising the module 120. The active balancing circuit 121 may balance the state of charge, rate of charge, or rate of discharge across the cells 110 comprising the module 120 and may be achieved using any number of techniques known in the art. In alternative embodiments, a passive balancing circuit may be employed in lieu of or in addition to the active balancing circuit 121.

In one embodiment, each module 120 may have a nominal voltage of 24V, a nominal capacity of 40 Ahr, a maximum continuous charge current of 120 A, a maximum continuous discharge current of 320 A, and a maximum 10 s discharge current of 700. In addition, each module 120 may have an ambient temperature range of 10° C. to 50° C. and an operating temperature range of −10° C. to 65° C. In another embodiment, each module 120 may have an expected battery life of at least 2000 cycles, each cycle being performed to 100% depth of discharge at a rate of 1 C and a temperature of 25° C.

Insofar as the following safety standards are desired, each module 120 may conform to UL 1973—“UL Standard for Batteries for Use in Stationary, Vehicle Auxiliary Power and Light Electric Rail (LER) Applications,” UL94-V0—“Standard for Safety of Flammability of Plastic Materials for Parts in Devices and Appliances,” UN3480-Class 9—“Transportation Requirements for Lithium-ion Batteries,” and IP56—“Ingress Protection Rating.”

Each cell 110 possesses one or more cell metrics indicative of a status of that cell 110 and each module 120 possesses one or more module metrics indicative of a status of that module 120. For example, cell metrics may comprise a voltage of each cell 110, a current of each cell 110, a state of charge of each cell 110, and a temperature of each cell 110; module metrics may comprise a voltage of each module 120, a current of each module 120, a state of charge of each module 120, and a temperature of each module 120; and, where applicable, cell pack metrics may comprise a voltage of each cell pack, a current of each cell pack, a state of charge of each cell pack, and a temperature of each cell pack.

A plurality of sensors 122 configured to measure the aforementioned metrics may accompany each module 120. For example, a plurality of temperature sensors may be configured to measure individual cell, cell pack, or module temperatures at several significant locations. Voltmeters, ammeters, equivalent measurement circuitry and other measurement circuitry may be configured to measure the relevant electrical metrics as determined by specific applicational requirements. Any number of additional sensors 122 pertinent to the operation or status of the battery system 100 including, but not limited to, those of humidity, pressure, acceleration, and light, may be installed so long as the output of each sensor is communicatively communicated to the control unit 140. Any combination of the aforementioned sensors 122 or yet additional sensors may be employed by the battery system 100 and no limitation is intended for the type or number of metrics that can be provided by each module 120.

In an embodiment, each module 120 further comprises a module board 123 configured to monitor the cell metrics of that module 120, compile the module metrics of that module 120, and communicate the cell and module metrics to the control unit 140. The module board 123 may be in the form of an integrated circuit, microprocessor, microcontroller, microchip, printed circuit board, or similar device capable of acquiring, compiling, and communicating sensor data. The module board 123 may incorporate the active balancing circuit 121—as in the activate balancing circuit 121 and module board 123 are part of a single component; or the two may be altogether distinct components of the module 120. Where no module board 122 is provided, the module 120 must nonetheless provide the metrics to the control unit 140 and may do so directly.

Each module 120 is communicatively connected to the control unit 140, in turn configured to monitor the metrics provided by each module 120, balance power across the modules 120, compile one or more battery system metrics, and calculate one or more last run scenarios. The control unit 140 may include a processor 141 for executing the balancing, monitoring, compiling, and calculating programs. The control unit 140 may also include a memory 142 comprising both a read-only memory (ROM) for storing the programs; and a random-access memory (RAM) serving as a working memory area for use in executing the programs stored in the ROM. Although a control unit 140 is shown, it is also possible and contemplated to use other electronic devices, such as a computer, microcontroller, application specific integrated circuit (ASIC), or similar.

In order to monitor the module metrics, the control unit 140 may receive pre-compiled metrics from each module board 123, from the measurement circuitry and sensor outputs of each module 120 directly, or from some combination of the two. No limitation is intended for the type or number of metrics that can be received by the control unit 140, so long as adequate infrastructure for measurement and communication is provided. In one embodiment, the control unit 140 is configured to monitor at least a voltage of each module 120, a current of each module 120, a state of charge of each module 120, temperatures from at least 6 cells 110 per module 120, and temperatures from at least 3 locations per module 120.

The control unit 140 is configured to actively balance power across the modules 120 comprising the battery system 100, analogous to the function of the active balancing circuit 121 within each module 120. In particular, the control unit 140 may balance the states of charge, rates of charge, or rates of discharge across the modules 120. In alternative embodiments, the control unit 140 is configured to passively balance power across the modules 120 in lieu of or in addition to active balancing provisions.

The control unit 140 is configured to compile battery system metrics from the received cell metrics and module metrics. These system metrics reflect the status of the system 100 as a whole, and may comprise a battery system voltage, a battery system current, and a battery system state of charge.

The control unit 140 is configured to calculate one or more last run scenarios for each elevator car 11 being driven by the battery system 100, wherein a last run scenario refers to a remaining quantity of elevator car runs or calls that can safely driven. The last run scenario may utilize any of the foregoing metrics as inputs to a calculation, function, or program by the control unit 140. In an embodiment, at least the battery system metrics, preinstalled data stored inside the memory 142 of the control unit 140, and data received from the elevator system 10 are used as inputs in this function. However, the particular metrics and data utilized in the last run scenario may be determined by the specific applicational requirements, and no limitation is intended to restrict their type or quantity. In one example, the battery system metrics may pertain to the system state of charge and system temperatures; the preinstalled data may pertain to the physical properties of each elevator car 11, including mass, acceleration profiles, and power consumption; and the data received may pertain to the number of queued calls and their respective floors.

The networking unit 150, communicatively connected to the control unit 140 and the elevator system 10, communicates the battery system metrics and the last run scenarios to the elevator system 10. In an embodiment, the networking unit 150 further receives data from the elevator system 10 to be communicated to the control unit 140, including, for example, data inputted into the last run scenario functions. The communicative connection between the control unit 140, networking unit 150, and elevator controller 12 may be established according to specific application requirements, and no limitation is intended to restrict the type of connection or quantity of communication. For example, the control unit 140 may provide an open-loop output to the elevator controller 12, in which case the networking unit 150 need only transmit data; or the control unit 140 and elevator controller 12 may be components of a closed-loop system, in which case both transmitting and receiving functionality is required.

In an embodiment, the networking unit 150 is communicatively connected to the central monitoring station 30, wherein the battery system metrics and last run scenarios may be communicated thereto as well. The central monitoring system 30 may be a LiftNet™ system, monitoring system run by a local municipality, or similar supervisory system responsible for the management of a plurality of local elevator systems 10.

In an embodiment, the individual cell metrics, cell pack metrics, and/or module metrics of the system 100 may also be communicated with the elevator system 10 and/or the central monitoring station 30 through the networking unit 150. It should be understood that any unprivileged information available to the control unit 140 may be communicated to the elevator system 10 and/or central monitoring station 30 using the infrastructure disclosed herein.

The networking unit 150 may be configured to communicate through a Controller Area Network (CAN) protocol, Modbus Transmission Control Protocol/Internet Protocol (TCP/IP), or other equivalent networking protocols.

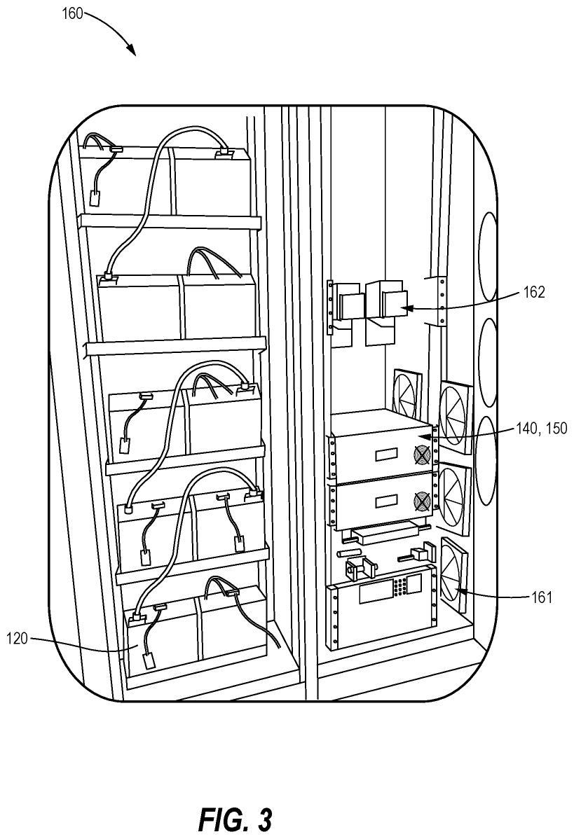

Turning now to FIG. 3, a battery enclosure 160 comprising electrically connected modules 120 and a circuit breaker 162 is provided for storage and protection of the battery system 100. In an embodiment, multiple modules 120 may be connected only within one enclosure 160 or across multiple enclosures 160. Likewise, both the control unit 140 and the networking unit 150 may be housed in one enclosure 160, across multiple enclosures 160, or in an exterior location altogether. Each enclosure 160 may include various electrical components to connect or protect the enclosed devices, including any number of switches, contactors, relays, cables, bus bars, fuses, breakers, etc., the details of which, unless otherwise mentioned, will not be further discussed.

The enclosure 160 has a front access suitable for installation and maintenance of the battery system 100 and one or more secondary accesses on the sides, top, bottom, or back for cable entry and exit. The quantity, size, and type of incoming and outgoing cabling may be decided when considering specific application requirements, and particularly when considering the required power output of the battery system 100. Adequate space may be allocated within the enclosure 160 for a maximum number of incoming and outgoing cables in accordance with the NEC—“Standards for Minimum Bend Radius.” In an embodiment, the enclosure 160 may have a width of 30″ or less, a length of 35″ or less, and a height of 80″ or less.

The enclosure 160 is the first of many safety features built into the system 100 and designed to provide defense-in-depth against both incidental risks and malicious attacks. In an embodiment, each enclosure 160 may meet or exceeds a NEMA 12—“Enclosure Rating,” be powder coated in ANSI 60 Gray finish or equivalent, and meet local seismic code requirements. Each enclosure 160 may further comprise a ventilation apparatus 161 to maintain ambient and operating temperatures for the enclosed equipment. The ventilation apparatus 161 may be capable of maintaining a temperature differential between each module in the enclosure to under 5° C.

To protect the housed components, each enclosure 160 comprises a DC rated circuit breaker 162 electrically connected to the modules 120 comprising the enclosure 160 and communicatively connected to the control unit 140. The circuit breaker 162 comprises an A/B auxiliary switch and at least one of an undervoltage release and a shunt trip. Under this configuration, the circuit breaker 162 can trigger independently, be actuated by the control unit 140, or be remotely and manually switched exterior to the enclosure 160. In each case, the status of the circuit breaker 162 is communicated to the control unit 140.

While the circuit breaker 162 may be triggered independently, additional defense-in-depth is provided by one or more safety protocols programmed into the control unit 140. In an embodiment, upon a detection of a corresponding trigger, which may be an over charge, over discharge, over/under temperature, over/under current, or over/under voltage, the control unit 140 is configured to communicate a warning to the elevator system 10 and activate one or more safety mechanisms. Additional triggers, for example those pertaining to faulty communications and faulty connections, may also be programmed into the control unit 140 and no limit is intended for the type and number of triggers which may be employed.

Each safety mechanism is programmed to respond to its corresponding trigger. For example, a trigger for over discharge may activate a safety mechanism to open the contactors connecting the relevant modules 120, thereby providing an additional layer of defense for the components of battery system 100 if the circuit breaker 162 fails to trigger. In an embodiment, each safety protocol may further comprise communicating a warning to the central monitoring station 30 in addition to the elevator system 10. An audiovisual alarm, for instance one which activates a loud noise or flashing light proximate to the enclosure 160, is also possible and contemplated.

In an embodiment, the battery system 100 is further configured with a failsafe mode that electrically disengages the modules 120 if the system 100 is damaged or loses power. Blockchain security protocols may also be embedded into the software of the control unit 140, such that records of energy transactions or other data are securely recorded onto the blockchain. Further, if the elevator system 10 is configured with regenerative braking capabilities, the power generated therein may be returned to the battery system 100 during blackout conditions.

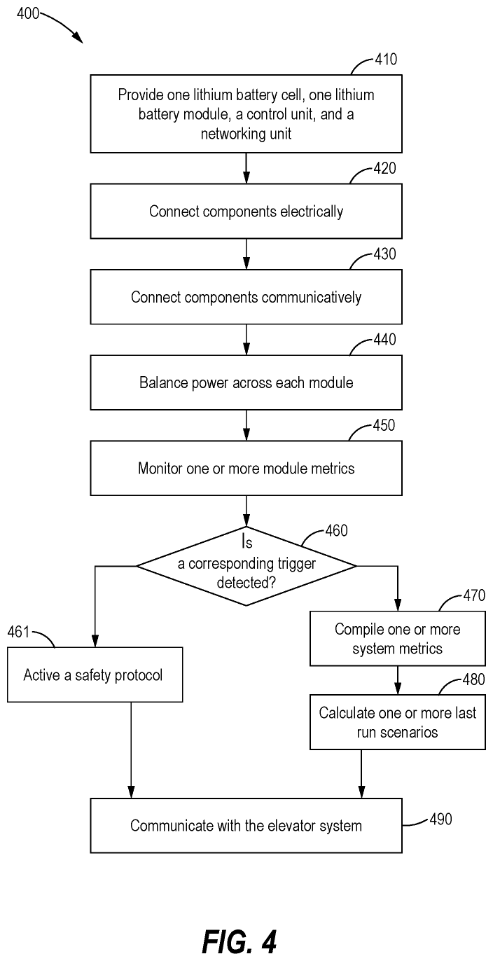

Turning now to FIG. 4, a method of providing standby power to an elevator system 10 is generally referred to by a reference numeral 400. The method may begin as shown in block 410 by providing a lithium battery cell 110, a lithium battery module 120, a control unit 140 and a networking unit 150. In block 420, the cells 110 in each module 120 are electrically connected and the modules 120 are electrically connected to the elevator system 10. In block 430, each module is communicatively connected to the control unit 140 and the networking unit 150 is communicatively connected to the control unit 140 and the elevator system 10. In an embodiment, the networking unit 150 is further communicatively connected with a central monitoring station 30.

Where blocks 410-430 disclose an installation of the battery system 100, the following steps disclose a plurality of processes run by the system 100 during operation.

In a first process shown in block 440, the control unit 140 balances power across each module 120. In a second process shown in block 450, the control unit 140 monitors one or more module metrics. In an embodiment and third process shown in block 460, the system 100 detects for a corresponding trigger, for instance that of an over/under temperature, over/under current, over/under voltage, etc. If a corresponding trigger is detected, the battery system 100 proceeds to block 461, wherein a safety protocol is activated in response to the corresponding trigger. Each safety protocol further comprises activating one or more safety mechanisms, and, as shown in block 490, communicating a warning to the elevator system 10.

Conversely, if no corresponding trigger is detected, the battery system 100 continues to block 470, wherein the control unit 140 compiles one or more battery system metrics from the one or more module metrics. Next, in block 480, at least the one or more battery system metrics are used to calculate one or more last run scenarios. In a final process shown in block 490, at least the battery system metrics and the last run scenarios are communicated to the elevator system 10 through the networking unit 150.

In an embodiment, the step of calculating the one or more last run scenarios in block 480 may comprise the control unit 140 first receiving data from the elevator system 10. The control unit 140 then calculates the last run scenarios using a combination of the battery system metrics, the received data, and data preinstalled in the memory 142 of the control unit 140. Where the control unit 140 receives data from and transmits data to the elevator system 10, the control unit 140 and elevator system 10 may comprise a closed-loop system.

In an embodiment, the information communicated to the elevator system 10 in block 490, including the battery system metrics, calculated last run scenarios, and warnings associated with each safety protocol, may also be communicated with the central monitoring station 30. In other words, the elevator system 10 and central monitoring station 30 may be privileged to the same information.

It should be understood that while blocks 410-430 disclose an installation of the system 100 and must necessarily precede blocks 440-490, blocks 440-490 need not operate sequentially and may be executed in series, parallel, or any combination of series and parallel sequence. For instance, the one or more module metrics monitored in block 450 may be communicated to the elevator system 10 prior to or concurrent to the battery system metrics being compiled in block 470; and/or the one or more system metrics compiled in block 470 may be communicated to the elevator system 10 prior to or concurrent to the last run scenarios being calculated in block 480. In various embodiments, each of blocks 440-490 may be repeated continuously or discretely at a frequency set according to the specific applicational requirements.

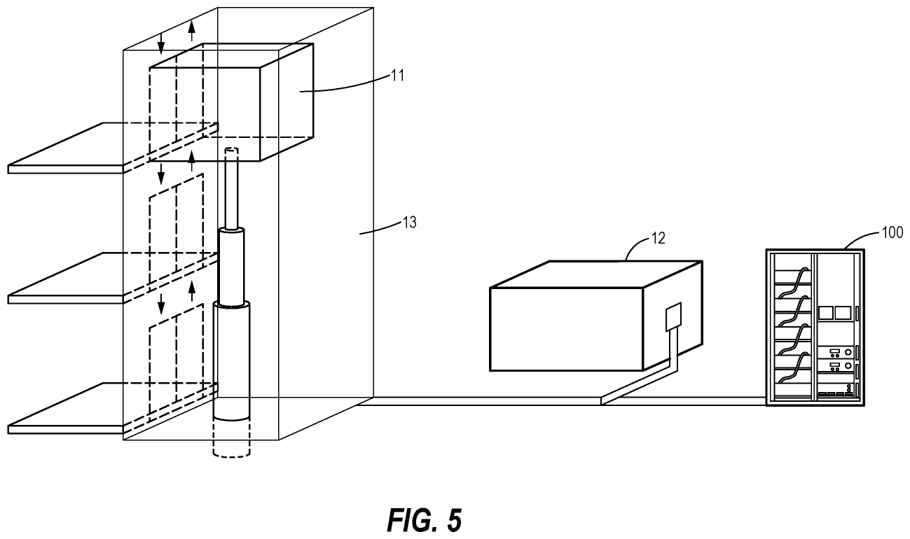

FIG. 5 is a schematic illustration of an elevator system 10 in accordance with the present disclosure. The elevator system 10 includes an elevator shaft 13, an elevator car 11 adapted to traverse the elevator shaft 13, an elevator controller 12 commanding the operation of the elevator car 11, and an elevator back-up battery system 100 according to any of the foregoing embodiments of the disclosure. While a single shaft 13, car 11, and elevator controller 12 are depicted, it should be understood that the elevator system 10 may comprise one or more cars 11, each traversing a respective shaft 13 and being controlled by one or more elevator controllers 12. In addition, it should be appreciated that the battery system 100 may provide electrical power to the elevator system 10 through any number of intervening infrastructures (e.g. transformers, converters, rectifiers, etc.) not depicted.

In an embodiment, the elevator system 10 is further communicatively connected to a central monitoring station 30, wherein any information known to the elevator system 10 and battery system 100 may be related thereto.

### INDUSTRIAL APPLICATION

The elevator back-up battery system 100 of the present disclosure may be employed with a variety of elevator systems 10 requiring standby power, such as, but not limited to, hydraulic elevators, geared and gearless traction elevators, or machine-room-less elevators. The elevator systems 10 may operate in a residential context, for example an apartment complex or private home; a commercial context, for example an office building or shopping center; or an industrial context, for example a freight elevator or mining elevator. In each case, it is desirable to enhance the safety of the elevator users by providing robust back-up power during blackout conditions.

During normal operation, the battery system 100 is maintained at full charge from a same power supply driving the elevator system 10. In emergency situations, however, the full charge of the battery system 100 provides sufficient standby power for the elevator system 10 to collect the passengers on each landing over multiple trips. Communications between the battery system 100 and elevator system 10 convey battery system metrics that enable informed decisions for a viable number of future traversals. At the same time, the battery system 100 self-manages its system metrics for improved performance and provides safety protocols for improved reliability. Any or all of the information known to the battery system 100 and elevator system 10 may be further communicated to a central monitoring station 30 responsible for the management of a plurality of local elevator systems 10.

While the preceding text sets forth a detailed description of numerous different embodiments of the present disclosure, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date herein, which would still fall within the scope of the claims defining the scope of protection.

What is claimed is:

1. An elevator back-up battery system for providing standby power to an elevator system, comprising:
a lithium battery cell, the cell having one or more cell metrics;
a lithium battery module comprising electrically connected cells, the module having one or more module metrics;
a control unit communicatively connected to the modules and configured to balance power across the modules, monitor the module metrics, compile one or more battery system metrics, and calculate one or more last run scenarios; and
a networking unit communicatively connected to the control unit and the elevator system and configured to communicate the battery system metrics and the last run scenarios to the elevator system.

2. A method for providing standby power to an elevator system comprising:
providing a lithium battery cell, a lithium battery module, a control unit, and a networking unit;
connecting, electrically, the cells in each module; connecting, electrically, each module to the elevator system;
connecting, communicatively, each module to the control unit;
connecting, communicatively, the networking unit with the control unit and the elevator system; balancing, with the control unit, power across each module; monitoring, with the control unit, one or more module metrics; compiling, with the control unit, one or more system metrics; and
calculating, with the control unit, one or more last run scenarios; and communicating, with the networking unit, the system metrics and the last run scenarios to the elevator system.

3. An elevator system comprising:
an elevator shaft;
an elevator car adapted to traverse the shaft;
an elevator controller; and
and an elevator back-up battery system according to claim 1.
